(19) United States
(12) Patent Application Publication
(10) Pub. No.: US 2007/0080481 A1
(43) Pub. Date: Apr. 12, 2007

(54) Apparatus and methods for fabrication of composite components

(75) Inventor: Max U. Kismarton, Renton, WA (US)

Correspondence Address: LEE & HAYES, PLLC, 421 W. RIVERSIDE AVE., SUITE 500, SPOKANE, WA, 99201, US

(73) Assignee: The Boeing Company, Chicago, IL (US)

(21) Appl. No.: 11/248,760

(22) Filed: Oct. 12, 2005

(51) Int. Cl. B29C 43/10; B29C 43/52; B29C 71/02

(52) U.S. Cl. 264/236; 264/313; 264/314; 425/389; 425/383

(57) ABSTRACT

Apparatus and methods for fabrication of composite components are disclosed. In one embodiment, an apparatus for fabricating a component from a composite material includes a containment member having an internal volume adapted to receive the composite material, and a lid member. An expandable member is disposed within the internal volume adjacent to the composite material, the expandable member being inflatable within the internal volume and adapted to apply an elevated pressure against the composite material that urges the composite material against at least one of the containment member and the lid member. The containment member, the lid member, and the expandable member are further adapted to withstand at least one of the elevated pressure and an elevated temperature suitable for curing the composite material.

### GOVERNMENT LICENSE RIGHTS

This invention was made with Government support under contract number MDA972-98-9-0004 awarded by the Defense Advanced Research Projects Agency. The Government has certain rights in this invention.

### CROSS REFERENCE TO RELATED APPLICATIONS

This patent application is related to co-pending, commonly-owned U.S. Patent Application No. (t.b.d.) entitled “Conducting Fiber De-icing Systems and Methods” filed concurrently herewith on Oct. 12, 2005 under Attorney Docket No. BING-1-1166, which application is incorporated herein by reference.

### FIELD OF THE INVENTION

The present disclosure relates to composite component fabrication, and more specifically, to apparatus and methods for fabrication of composite components using a sealable container assembly.

### BACKGROUND OF THE INVENTION

High strength, light weight composite components are being utilized in a wide variety of articles of manufacture. This is particularly true in the field of aircraft manufacturing. Typical materials used in the manufacture of composite components include glass or graphite fibers that are embedded in resins, such as phenolic, epoxy, and bismaleimide resins. The fiber and resin materials may be formed into a desired shape using a variety of different manufacturing systems and processes, and may then be cured (e.g. under elevated pressure and temperature conditions) to produce the desired component.

Prior art systems for fabricating composite components typically use an autoclave for providing the elevated pressure and temperature conditions necessary for curing of the resinous materials used to form the components. For example, FIG. 1 is an end cross-sectional view of a system 100 for manufacturing composite components in accordance with the prior art. The system 100 includes an autoclave 110, and a forming tool 120 removably positioned within the autoclave 110. Typically, an uncured composite material 122 is positioned on the forming tool 120, and a vacuum bag 124 is positioned over the composite material 122. One or more seals 126 are positioned between the vacuum bag 124 and the forming tool 120 and a space 128 surrounding the composite material 122 between the vacuum bag 124 and the forming tool 120 is evacuated. After evacuation, an elevated pressure P_{E} and an elevated temperature T_{E} are created within the autoclave 110 for a desired period of time. The elevated temperature T_{E} serves to cause the resin within the uncured composite material 122 to flow, and the elevated pressure P_{E} compacts the composite material 122 to reduce the porosity of the resulting composite component, and to cause the composite material 122 to closely conform to the shape of the forming tool 120. The continued application of the elevated temperature T_{E} then serves to cure and solidify the composite material 122. After it is cured the elevated pressure P_{E} and the elevated temperature T_{E} conditions are removed, and the resulting composite component is removed from the autoclave 110.

Although desirable results have been achieved using such prior art systems, there is room for improvement. For example, as the size of composite components increases, the cost of suitable autoclaves for fabricating such components also increases. Autoclaves large enough to create suitable elevated pressure and temperature conditions for the fabrication of large composite components, such as components suitable for the manufacture of modern aircraft, typically cost between approximately $20 M to $40 M or more. Therefore, apparatus and methods for fabricating relatively large composite components that at least partially mitigate the costs associated with such fabrication systems would have utility.

### SUMMARY OF THE INVENTION

The present invention is directed to apparatus and methods for fabrication of composite components using a sealable container assembly. Embodiments of the present invention may advantageously reduce the tooling costs associated manufacturing composite components, and may improve the efficiency of the composite component manufacturing process, in comparison with prior art manufacturing systems and processes.

In one embodiment, an apparatus for fabricating a component from a composite material includes a containment member having an internal volume adapted to receive the composite material, and a lid member. An expandable member is disposed within the internal volume adjacent to the composite material, the expandable member being inflatable within the internal volume and adapted to apply an elevated pressure against the composite material that urges the composite material against at least one of the containment member and the lid member. The containment member, the lid member, and the expandable member are further adapted to withstand at least one of the elevated pressure and an elevated temperature suitable for curing the composite material.

### BRIEF DESCRIPTION OF THE DRAWINGS

Embodiments of the present invention are described in detail below with reference to the following drawings.

FIG. 1 is an end cross-sectional view of a system for manufacturing composite components in accordance with the prior art;

FIG. 2 is an isometric view of a system for manufacturing composite components in accordance with an embodiment of the invention;

FIG. 3 is a first cross-sectional view of the system for manufacturing composite components of FIG. 2 taken along line 3-3;

FIG. 4 is a flow chart of a method of fabricating composite components in accordance with yet another embodiment of the invention;

FIG. 5 is a representative curing cycle for curing a composite component within the system of FIG. 2 in accordance with another embodiment of the invention;

FIG. 6 is a series of cross-sectional views of a composite component formed using a system for manufacturing composite components in accordance with another embodiment of the invention;

FIG. 7 is a cross-sectional view of a system for manufacturing composite components in accordance with yet another embodiment of the invention;

FIG. 8 is a side cross-sectional view of a composite component formed using the system of FIG. 7 in accordance with a further embodiment of the invention; and

FIG. 9 is a side elevational view of an aircraft having one or more composite components formed in accordance with alternate embodiments of the invention.

### DETAILED DESCRIPTION

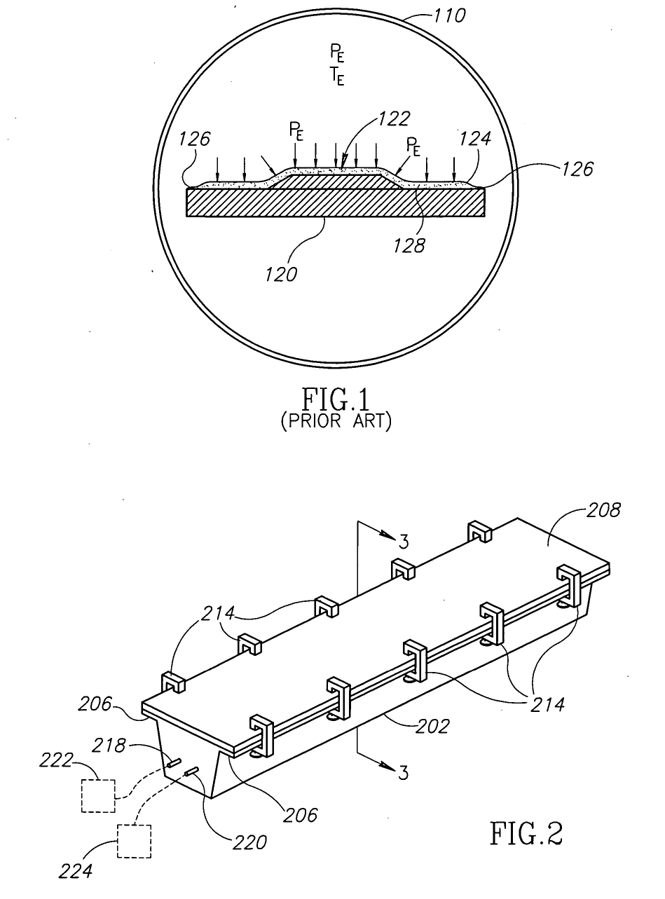

The present invention relates to apparatus and methods for fabrication of composite components using a sealable container assembly. Many specific details of certain embodiments of the invention are set forth in the following description and in FIGS. 2-9 to provide a thorough understanding of such embodiments. The present invention, however, may have additional embodiments, or may be practiced without one or more of the details described below.

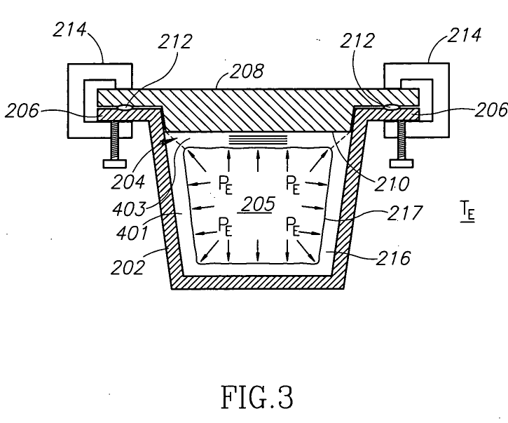

FIG. 2 is an isometric view of a system 200 for manufacturing composite components in accordance with an embodiment of the invention. FIG. 3 is a cross-sectional view of the system 200 of FIG. 2 taken along line 3-3. In this embodiment, the system 200 includes a containment member 202 having an opening 204 leading to an internal volume 205, and flanges 206 extending outwardly from opposing sides proximate the opening 204. A lid member 208 is positioned on the containment member 202, and includes an insertion portion 210 (FIG. 3) that fittingly engages within the opening 204 of the containment member 202. One or more seals 212 are disposed around the opening 204 between the containment member 202 and the lid member 208, and a plurality of clamps 214 secure the lid member 208 to the flanges 206 of the containment member 202.

As shown in FIG. 3, an expandable member (or bladder) 217 is positioned within the internal volume 205 of the containment member 202. The expandable member 217 may be formed of silicone, or any other suitable material. A composite material 216 is formed at least partially around the expandable member 217, and is positioned between the expandable member 217 and the containment and lid members 202, 208. In some embodiments, the composite material 216 may be formed using successive layers of a fiber-containing resinous material. For example, in alternate embodiments, the fibers within the composite material 216 may include glass, graphite, or polymeric fibers, and the resinous material may include phenolic, epoxy, or bismaleimide resins. Of course, in other embodiments, any suitable materials may be used.

As further shown in FIG. 2, a first port 218 is disposed through the containment member 202 and is in fluid communication with the internal volume 205 of the containment member 202. A second port 220 is also disposed through the containment member 202 and is in fluid communication with the expandable member 214. A vacuum source 222 may be coupled to the first port 218, and a pressure source 224 may be coupled to the second port 220. In alternate embodiments, one or both of the first and second ports 218, 220 may be disposed through the lid member 208, depending on the particular configuration of the composite component 216.

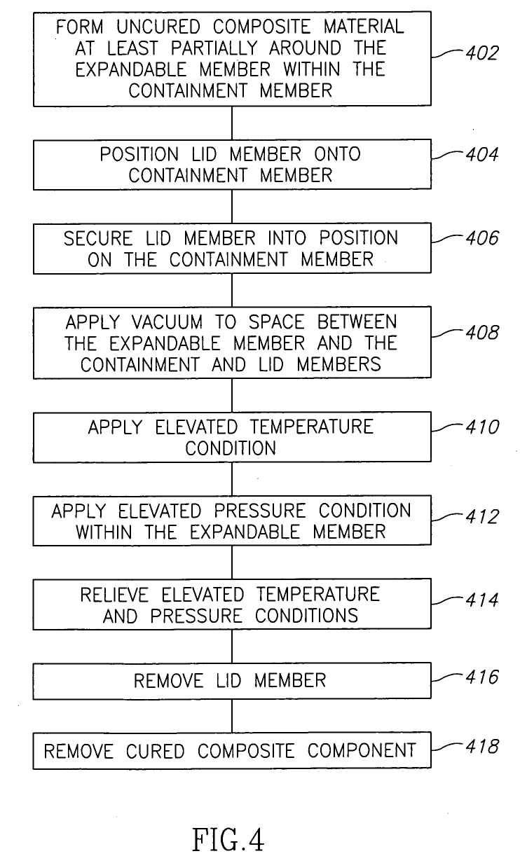

FIG. 4 is a flow chart of a method 400 of fabricating composite components in accordance with yet another embodiment of the invention. As shown in FIG. 4, the method 400 includes forming the uncured composite material at least partially around the expandable member 217 within the containment member 202 at a block 402. For example, in one particular embodiment, an approximately “U-shaped” portion 401 of uncured composite material is formed on the inner surfaces of the containment member 202, the expandable member 217 is positioned within the “U-shaped” portion, and a second, relatively flat portion 403 of uncured composite material is then formed over the expandable member 217. At a block 404, the lid member 208 is positioned onto the containment member 202 with the insertion portion 210 fittingly engaged into the opening 204 of the containment member 202. The lid member 208 is secured to the containment member 202 at a block 406. For example, in one embodiment, the clamps 214 are used to clamp the lid member 208 to the flanges 206 of the containment member 202.

At a block 408, a vacuum is applied to the space between the expandable member 217 and the containment and lid members 202, 208. More specifically, the vacuum source 222 is used to pull vacuum through the first port 218, evacuating the space around the uncured composite material. At a block 410, an elevated temperature T_{E} is applied to the system 200, such as by installing the system 200 into an oven. At a block 412, an elevated pressure P_{E} is applied within the expandable member 217, such as by providing a pressurized gas or fluid from the pressure source 224 through the second port 220. The elevated temperature and pressure conditions T_{E}, P_{E} may be applied (blocks 410, 412) for one or more periods as desired to suitably cure the composite material 216 within the system 100. Next, at a block 414, the elevated temperature and pressure conditions T_{E}, P_{E} are relieved, and the lid member 208 is removed at a block 416. The cured composite component 216 is then removed from the system 100 at a block 418.

Because in some embodiments, the containment member 102 and the lid member 108 may be heated and cooled with the composite component 216 engaged within the internal volume 205, it may be desirable that containment and lid members 102, 108 have coefficient of thermal expansion characteristics that are very similar to that of the composite component 216. In one particular embodiment, for example, the containment and lid members 102, 108 may be formed of a Nickel-containing steel alloy commonly referred to as Invar steel and known for its relatively low thermal expansion coefficient. Alternately, the containment and lid members 102, 108 may be formed of aluminum, steel, titanium, or any other suitable materials. With continued reference to FIG. 4, in alternate embodiments of methods in accordance with the present invention, the cured composite component may be removed from the containment member (block 418) prior to the relieving of the elevated temperature condition (block 414) to prevent damage to the cured composite component by the differential thermal expansion/contraction during cooling of the containment and lid members 102, 108.

It will be appreciated that embodiments of apparatus and methods in accordance with the present invention may provide significant advantages over the prior art. For example, because fabrication systems in accordance with the present invention utilize an expandable member to provide the desired pressure conditions on the composite component, and because the entire system may be installed into an oven that operates at normal ambient pressures to provide the desired temperature conditions, the need for large autoclaves is eliminated. Also, the costs of pumps, vacuums, and heating systems used in embodiments of the invention may be substantially reduced in comparison with those systems used in prior art manufacturing assemblies. Thus, embodiments of the invention may significantly reduce the tooling costs associated manufacturing composite components in comparison with prior art manufacturing systems. In some embodiments, for example, manufacturing systems in accordance with the invention may cost approximately two orders of magnitude less than prior art systems requiring an autoclave.

Embodiments of the invention may also improve the efficiency of the manufacturing process. For example, because the volumes that are pressurized within the expandable member may be substantially smaller than the volumes of prior art autoclaves, the portions of the manufacturing process that involve subjecting the composite components to an elevated pressure condition may be performed more quickly and efficiently in comparison with the prior art manufacturing processes.

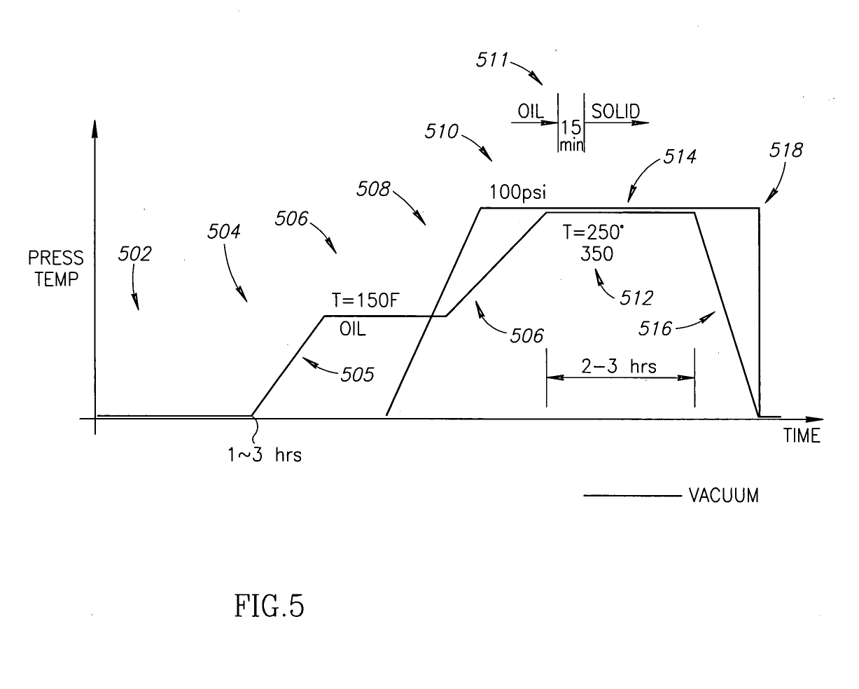

It will be appreciated that the values and durations of the elevated temperature T_{E} and the elevated pressure P_{E} conditions may vary depending on the particular design features of the composite component being formed, including the resinous materials and fiber materials contained in the uncured composite material. For example, FIG. 5 is a representative curing cycle 500 for curing a composite component within the system of FIG. 2 in accordance with another embodiment of the invention. In this embodiment, the curing cycle 500 includes a first portion 502 of approximately 1 to 3 hours in duration wherein vacuum is applied to the volume containing the uncured composite material, prior to the elevation of the temperature and pressure within the system 100. During a second portion 504 of the curing cycle 500, the vacuum continues to be applied while the temperature of the system 100 is gradually elevated from a non-elevated temperature level to a first temperature level (e.g. approximately 150° F.) and maintained at that level for a first period of time.

During a third portion 506, with the vacuum applied and the temperature maintained at the first temperature level, the pressure within the expandable member 217 begins to be increased from a non-elevated pressure level. At some point, typically during the second or third portions 504, 506 of the curing cycle 500, a resinous portion of the uncured composite material undergoes a first phase change 505 from a first solid state to an oil (or liquid or semi-liquid) state. As the pressure continues to be increased within the expandable member 217, the temperature of the system 100 begins increasing again during a fourth portion 508 of the curing cycle 500. During a fifth portion 510 of the curing cycle 500, the pressure reaches a first elevated pressure level (e.g. approximately 100 psi) and is held constant at that level while the temperature continues to increase to a second elevated temperature level (e.g. between approximately 250° F. to 350° F.).

During a sixth portion 512 of the curing cycle 500, the pressure is maintained at the first elevated pressure level and the temperature is maintained at the second elevated temperature for a specified curing period (e.g. approximately 2 to 3 hours). At some point, typically during the sixth portion 512, the resinous portion of the composite material undergoes a second phase change 511 from the oil (or liquid or semi-liquid) state to a second solid state. Also, at a vacuum termination point 514 during the sixth portion 512 (e.g. approximately half way through the specified curing period) the vacuum is removed. During a seventh portion 516 of the curing cycle 500, the pressure within the expandable member 217 is maintained at the first elevated pressure level while the temperature of the system 100 is cooled to the non-elevated temperature level. Finally, with the temperature reduced to the non-elevated temperature level, the pressure is reduced to the non-elevated pressure level during an eighth portion 518 of the curing cycle 500.

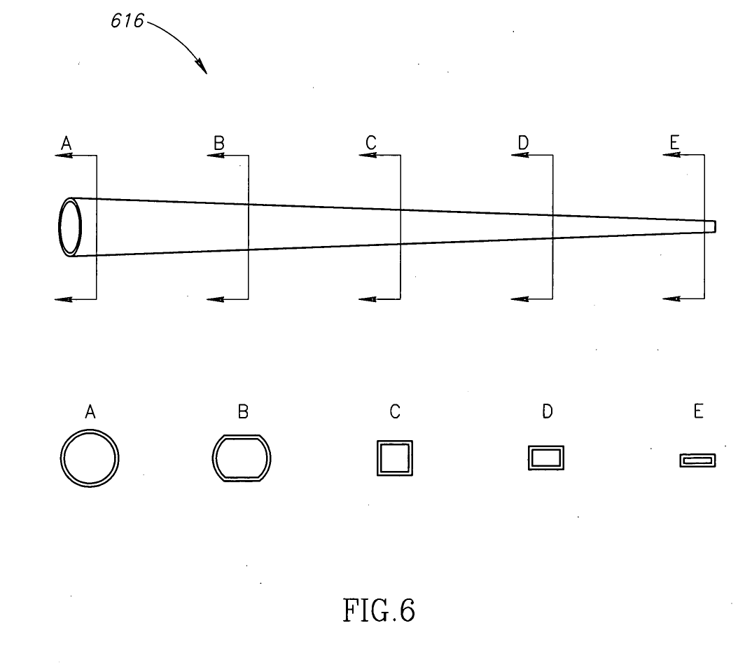

Referring again to FIG. 3, it should be appreciated that the cross-sectional shape of the composite component 216 fabricated using embodiments of the present invention is not limited to the particular embodiment shown in FIG. 3. Composite components having a variety of different cross-sectional shapes may be formed using embodiments of the present invention. Also, the cross-sectional shape of the composite components may remain constant or may vary along the length of the containment member 202. For example, FIG. 6 is a series of cross-sectional views of a composite component 616 formed using a system 600 for manufacturing composite components in accordance with another embodiment of the invention. As shown in FIG. 6, the cross-sectional shape of the composite component 616 varies from an approximately circular shape at a first station A, to an approximately square shape at a third station C, and to an approximately rectangular shape at a fifth station E. Of course, in alternate embodiments, composite components having other cross-sectional shapes may be fabricated.

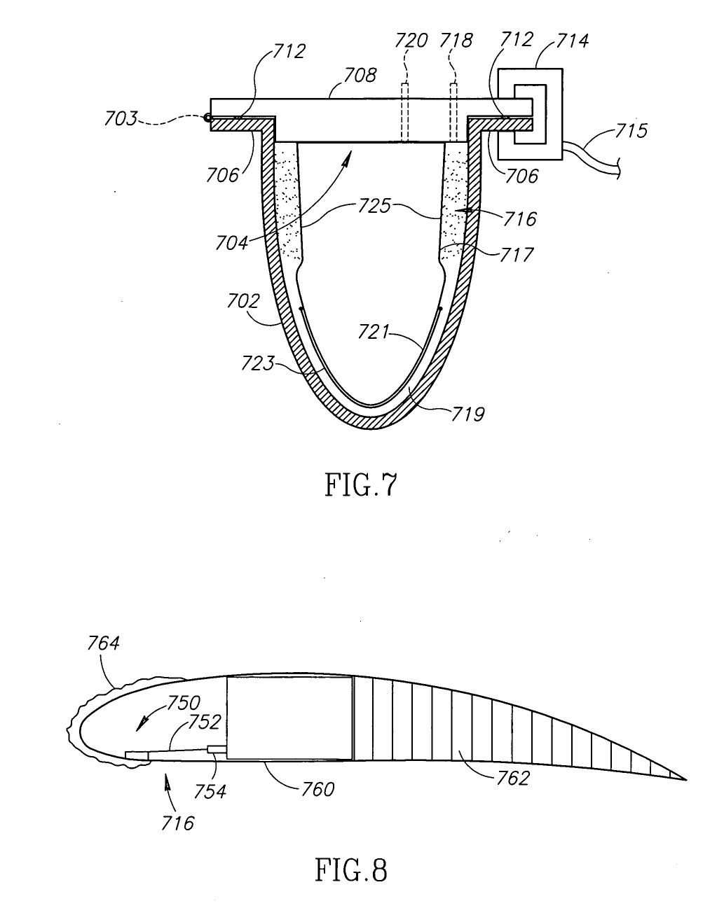

FIG. 7 is a cross-sectional view of a system 700 for manufacturing composite components in accordance with yet another embodiment of the invention. In this embodiment, the system 700 includes an approximately “U”-shaped containment member 702 having an opening 704 and flanges 706 extending outwardly from opposing sides proximate the opening 704. A lid member 708 is hingeably coupled to the containment member 702 by a hinge 703, and includes an insertion portion 710 that fittingly engages within the opening 704 of the containment member 702. Seals 712 are disposed around the opening 704 between the containment member 702 and the lid member 708. A locking device 714 secures the lid member 708 in a closed position over the opening 704 of the containment member 702. In this embodiment, the locking device 714 is coupled to a supply line 715 that provides a hydraulic (or pneumatic) flow to drive the locking device 714, thereby locking the lid member 708 in the closed position. The locking device 714 may be a separate component from the containment and lid members 702, 708, or alternately, may be integrally-formed with at least one of the containment and lid members 702, 708. In further embodiments, the locking device 714 may be any suitable type of device that secures the lid member 708 in the closed position, including an electrical device, a hydraulic device, a pneumatic device, a magnetic device, a mechanical device, or any other desired type of locking mechanism.

As shown in FIG. 7, an expandable member (or bladder) 717 is positioned within the containment member 702, and a composite component 716 is formed partially around the expandable member 717, and is positioned between the expandable member 717 and the containment member 702. In the manner described above with reference to FIG. 2, a vacuum source may be coupled to the space occupied by the composite component 716, and a pressure source may be coupled to the expandable member 717. In this embodiment, the composite component 716 includes a first composite layer 719, a second composite layer 721, and relatively thicker third composite portions 725 are coupled to the first and second composite layers 719, 721. A vacuum (or first) port 718 is disposed through the lid member 708 and is in fluid communication with the space'surrounding the composite component 716, while a pressure (or second) port 720 is disposed through the lid member 708 and is in fluid communication with the expandable member 717.

In some embodiments, a conductive-fiber layer 723 is formed between the first and second composite layers 719, 721, as shown in FIG. 7. More specifically, FIG. 8 is a side cross-sectional view of an airfoil section 800 that includes the composite component 716 of FIG. 7 in accordance with another alternate embodiment of the invention. In this embodiment, the airfoil section 800 includes the composite component 716 coupled to a central load-bearing portion 760, and a trailing edge portion 762 is coupled to the load-bearing portion 760. In one embodiment, the central load-bearing portion 760 may be a composite spar member formed using apparatus and methods in accordance with the invention, including, for example, the composite component 616 described above and shown in FIG. 6.

The airfoil section 800 further includes a deicing system 750, as disclosed more fully in co-pending, commonly-owned U.S. patent application Ser. No. ______ filed concurrently herewith under Attorney Docket No. BING-1-1166, which application is incorporated herein by reference. In this embodiment, the deicing system 750 includes a first conductive lead 752 coupled between the conductive-fiber layer 723 of the composite component 716, and a second conductive lead 754 coupled to a power source (not shown). As described more fully in the above-referenced U.S. patent application Ser. No. ______ (filed concurrently herewith under Attorney Docket No. BING-1-1166), the deicing system 750 may be operated to remove a layer of ice 764 that may form on a leading edge portion of the composite component 716. In one embodiment, the airfoil section 800 is a cross-sectional view of a rotor blade of a rotary aircraft. Alternately, the airfoil section 800 may be a portion of a wing, a control surface, or any other aerodynamically-shaped structure, including a portion of an aircraft or any other suitably-shaped structure.

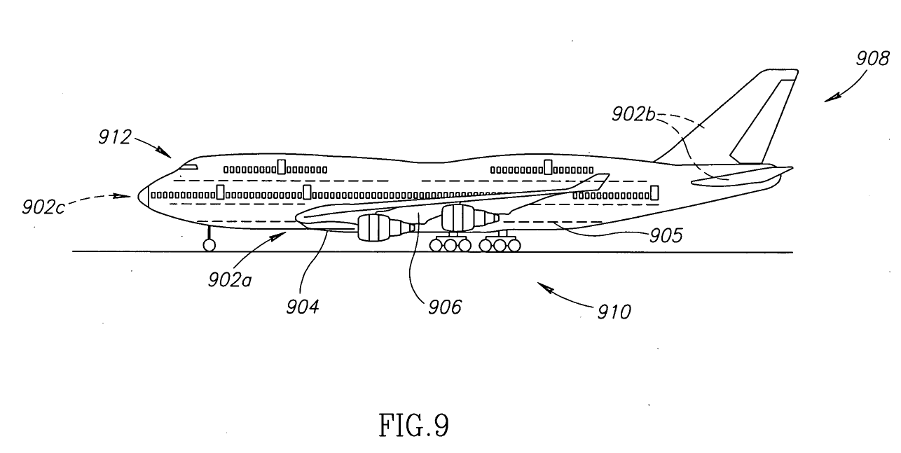

It will be appreciated that a wide variety of components and products may be manufactured using embodiments of the present invention, and that the invention is not limited to the specific embodiments described above and shown in the accompanying figures. For example, FIG. 9 is a side elevational view of an aircraft 900 having one or more composite components 902 formed in accordance with another embodiment of the invention. The aircraft 900 includes a fuselage 905 including wing assemblies 906, a tail assembly 908, and a landing assembly 910. The aircraft 900 further includes one or more propulsion units 904, a control system 912 (not visible), and a host of other systems and subsystems that enable proper operation of the aircraft 900. It will be appreciated that apparatus and methods in accordance with the present invention may be utilized in the fabrication of any number of composite components 902 of the aircraft 900, including, for example, the various components and sub-components of the tail assembly 908, the wing assemblies 906, the fuselage 905, and any other suitable portion of the aircraft 900. In general, except for the composite components 902 formed in accordance with the present invention, the various components and subsystems of the aircraft 900 may be of known construction and, for the sake of brevity, will not be described in detail herein.

Although the aircraft 900 shown in FIG. 9 is generally representative of a commercial passenger aircraft, including, for example, the 737, 747, 757, 767, 777, and 7E7 models commercially-available from The Boeing Company of Chicago, Ill. the inventive apparatus and methods disclosed herein may also be employed in the assembly of virtually any other types of aircraft. More specifically, the teachings of the present invention may be applied to the manufacture and assembly of other passenger aircraft, fighter aircraft, cargo aircraft, rotary aircraft, and any other types of manned or unmanned aircraft, including those described, for example, in The Illustrated Encyclopedia of Military Aircraft by Enzo Angelucci, published by Book Sales Publishers, September 2001, and in Jane's All the World's Aircraft published by Jane's Information Group of Coulsdon, Surrey, United Kingdom, which texts are incorporated herein by reference.

It may also be appreciated that alternate embodiments of apparatus and methods in accordance with the present invention may be utilized in the manufacture of a wide variety composite components for, for example, boats, automobiles, canoes, surfboards, recreational vehicles, or any other suitable vehicle or assembly. Embodiments of apparatus and methods in accordance with the present invention may be employed in the fabrication of a multitude of composite components, particularly components have a non-planar or arcuate outer surface. In some particular embodiments, for example, composite components fabricated in accordance with the teachings of the present disclosure may have a “C-channel” cross-sectional shape, which is a particularly common geometric shape for a variety of composite components, including but not limited to those used on aircraft (e.g. ribs or other structural members in empennage, wing, and flooring members of the aircraft).

As described above, embodiments of apparatus and methods in accordance with the present invention may substantially reduce the costs associated with manufacturing structures that include composite components. Because the tooling costs may be reduced, and the manufacturing process efficiencies may be improved, the costs associated with manufacturing structures that include composite components may be substantially improved in comparison with prior art systems and methods.

While preferred and alternate embodiments of the invention have been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. An apparatus for fabricating a component from a composite material, comprising:
a containment member having an internal volume adapted to receive the composite material and an opening leading to the internal volume;
a lid member adapted to cover the opening;
at least one locking device coupleable to the containment member and the lid member and adapted to securely engage the lid member to the containment member; and
an expandable member adapted to be disposed within the internal volume adjacent to the composite material, the expandable member being inflatable within the internal volume and adapted to apply an elevated pressure against the composite material that urges the composite material against at least one of the containment member and the lid member, wherein the containment member, the lid member, the at least one locking device, and the expandable member are further adapted to withstand at least one of the elevated pressure and an elevated temperature suitable for curing the composite material.

2. The apparatus of claim 1, wherein the lid member includes an insertion portion adapted to fittingly engage into the opening in the containment member.

3. The apparatus of claim 1, wherein the expandable member is fluidly coupled to a pressure port disposed through at least one of the containment member and the lid member.

4. The apparatus of claim 1, wherein the internal volume of the containment member is fluidly coupled to a vacuum port disposed through at least one of the containment member and the lid member.

5. The apparatus of claim 1, wherein the containment member comprises an elongated container having a cross-sectional shape that varies along a length of the elongated container.

6. The apparatus of claim 1, wherein the at least one locking device comprises at least one of an electrical device, a hydraulic device, a pneumatic device, a magnetic device, and a mechanical device.

7. The apparatus of claim 1, wherein the expandable member is fluidly coupled to a pressure port disposed through at least one of the containment member and the lid member, and wherein the internal volume of the containment member is fluidly coupled to a vacuum port disposed through at least one of the containment member and the lid member, the apparatus further comprising:
a pressure source operatively coupled to the pressure port and adapted to provide an elevated pressure within the expandable member; and
a vacuum source operatively coupled to the vacuum port and adapted to provide a vacuum within the internal volume.

8. The apparatus of claim 1, wherein at least one of the containment and lid members is formed from at least one of a nickel-containing steel alloy, steel, aluminum, and titanium.

9. The apparatus of claim 1, wherein the containment member includes at least one outwardly projecting flange, and wherein the locking device engages the flange and the lid member.

10. A method of manufacturing a composite component, comprising:
positioning a composite material within a containment member;
positioning an expandable member adjacent the composite material within the containment member;
securely enclosing the composite material and the expandable member within the containment member using a lid member;
curing the composite material within the containment member, including expanding the expandable member to apply an elevated pressure onto the composite material; and
removing the composite material from the containment member.

11. The method of claim 10, wherein curing the composite material further includes applying at least one elevated temperature to the composite material.

12. The method of claim 10, wherein curing the composite material further includes applying at least one elevated temperature to the composite material, the containment member, and the lid member.

13. The method of claim 10, wherein curing the composite material includes applying at least one elevated temperature to the composite material, the method further comprising removing the at least one elevated temperature, and removing the at least one elevated pressure.

14. The method of claim 13, wherein removing the composite material from the containment member includes removing the composite material after the removal of the at least one elevated temperature and the at least one elevated pressure.

15. The method of claim 13, wherein removing the composite material from the containment member includes removing the composite material after the removal of the at least one elevated pressure, but prior to the removal of the at least one elevated temperature.

16. The method of claim 10, wherein positioning an expandable member adjacent the composite material within the containment member includes positioning an expandable member adjacent a first portion of the composite material that is disposed between the containment member and the expandable member, and positioning the expandable member adjacent a second portion of the composite material that is disposed between the lid member and the expandable member.

17. The method of claim 10, wherein securely enclosing the composite material and the expandable member within the containment member using a lid member includes securing the lid member over an opening into the containment member using at least one of an electrical device, a hydraulic device, a pneumatic device, a magnetic device, and a mechanical device.

18. The method of claim 10, further comprising applying a vacuum to the composite material within the containment member.

19. The method of claim 10, wherein curing the composite material within the containment member includes:
applying a vacuum to the composite material within the containment member;
applying a first elevated temperature to the composite material for a first period of time;
applying a first elevated pressure to the composite material using the expandable member for a second period of time;
applying a second elevated temperature to the composite material for a third period of time;
removing the elevated pressure from the composite material; and
removing the second elevated temperature from the composite material.

20. The method of claim 10, wherein curing the composite material within the containment member includes:
applying at least one elevated pressure and temperature to the composite material within the containment member to cause a first phase change of the composite material from a first liquidous state; and
applying at least one other elevated pressure and temperature to the composite material within the containment member to cause a second phase change of the composite material from the first liquidous state to a second solid state.
